(19) United States
(12) Patent Application Publication
(10) Pub. No.: US 2024/0241509 A1
(43) Pub. Date: Jul. 18, 2024

(54) PLANT MONITORING DEVICE, PLANT MONITORING METHOD, AND PROGRAM

(71) Applicant: MITSUBISHI HEAVY INDUSTRIES, LTD., Tokyo (JP)

(72) Inventors: Kenji Takahashi, Kanagawa (JP); Hiroyasu Ishigaki, Kanagawa (JP); Yoshikane Yamanaka, Kanagawa (JP)

(73) Assignee: MITSUBISHI HEAVY INDUSTRIES, LTD., Tokyo (JP)

(21) Appl. No.: 18/563,537

(22) PCT Filed: May 23, 2022
(86) PCT No.: PCT/JP2022/021151

§ 371 Date: Nov. 22, 2023

(30) Foreign Application Priority Data
May 28, 2021 (JP) 2021-090185

(51) Int. Cl. G05B 23/02; G06F 3/0486

(52) U.S. Cl. CPC G05B 23/027; G05B 23/0272; G06F 3/0486

(57) ABSTRACT

A plant monitoring device (10) includes: an alert output unit (23) that, when an anomaly of a plant (1) is detected, creates alert information including a date and time of occurrence of the anomaly; an alert screen processing unit (251) that displays an alert screen on a display unit (19); and a graph screen processing unit (252) that displays a trend graph screen on the display unit (19). When the alert element displayed in the alert screen is dragged and dropped to the trend graph screen in a state where the alert screen and the trend graph screen are displayed, the graph screen processing unit (252) displays, in the trend graph screen, a graph of input data for a predetermined period including the date and time determined from the operated alert element and displays a highlighting element for highlighting the date and time in the trend graph screen.

### TECHNICAL FIELD

The present disclosure relates to a plant monitoring device, a plant monitoring method, and a program.

### BACKGROUND ART

For example, to stably operate a power plant, a thermal power plant, or the like, a reliable and easily operable plant monitoring device is required. In such a plant monitoring device, when an anomaly is detected, it is required to issue an alert and thereby quickly notify the operator of occurrence of the anomaly.

For example, Patent Literature I discloses a plant monitoring device that displays an alert screen, which is a list of alerts, on a display device and, when any of the alerts is selected and a graph display button is pressed by a user in the alert screen, causes a trend graph screen at the occurrence of the alert to be displayed on the display device.

### CITATION LIST

### Patent Literature

### [PTL 1]

Japanese Patent Application Laid-Open No. 2016-115195

### SUMMARY OF INVENTION

### Technical Problem

In the conventional method disclosed in Patent Literature 1, however, the user needs to perform two operations of selecting any of the alerts on the alert screen and then pressing the graph display button.

The present disclosure has been made in view of such circumstances and intends to provide a plant monitoring device, a plant monitoring method, and a program that can improve convenience of plant monitoring.

### Solution to Problem

To solve the problem described above, a plant monitoring device of the present disclosure includes: an alert output unit configured to, when an anomaly of a plant is detected, create alert information including a date and time of occurrence of the anomaly; an alert screen processing unit configured to display, on a display unit, an alert screen including an alert element based on the alert information; and a graph screen processing unit configured to display, on the display unit, a trend graph screen in which a temporal change of input data related to a monitoring item of the plant is rendered as a graph, and when the alert element displayed in the alert screen is dragged and dropped to the trend graph screen in a state where the alert screen and the trend graph screen are displayed on the display unit, the graph screen processing unit displays, in the trend graph screen, a graph of input data for a predetermined period including the date and time determined from the dragged and dropped alert element and displays a highlighting element for highlighting the date and time in the trend graph screen. The plant monitoring method of the present disclosure is performed by a computer, and the plant monitoring method includes: when an anomaly of a plant is detected, creating alert information including a date and time of occurrence of the anomaly; displaying, on a display unit, an alert screen including an alert element based on the alert information; displaying, on the display unit, a trend graph screen in which a temporal change of input data related to a monitoring item of the plant is rendered as a graph; and when the alert element displayed in the alert screen is dragged and dropped to the trend graph screen in a state where the alert screen and the trend graph screen are displayed on the display unit, displaying, in the trend graph screen, a graph of input data for a predetermined period including the date and time determined from the dragged and dropped alert element and displaying a highlighting element for highlighting the date and time in the trend graph screen.

The program of the present disclosure causes a computer to function as the plant monitoring device described above.

### Advantageous Effects of Invention

Convenience of plant monitoring can be improved.

### BRIEF DESCRIPTION OF DRAWINGS

FIG. 1 is a diagram illustrating an example of a hardware configuration of a plant monitoring device according to one embodiment of the present disclosure. FIG. 2 is a function block diagram illustrating an example of functions of the plant monitoring device according to one embodiment of the present disclosure.

FIG. 3 is a diagram illustrating an example of an alert screen according to one embodiment of the present disclosure.

FIG. 4 is a diagram illustrating an example of a trend graph screen according to one embodiment of the present disclosure.

FIG. 5 is a diagram illustrating an input operation and a screen display in response to the input operation in the plant monitoring device according to one embodiment of the present disclosure.

FIG. 6 is a diagram illustrating an example of a logic screen according to one embodiment of the present disclosure.

FIG. 7 is a diagram illustrating an input operation and a screen display in response to the input operation in the plant monitoring device according to one embodiment of the present disclosure.

### DESCRIPTION OF EMBODIMENTS

One embodiment of a plant monitoring device, a plant monitoring method, and a program according to the present disclosure will be described below with reference to the drawings.

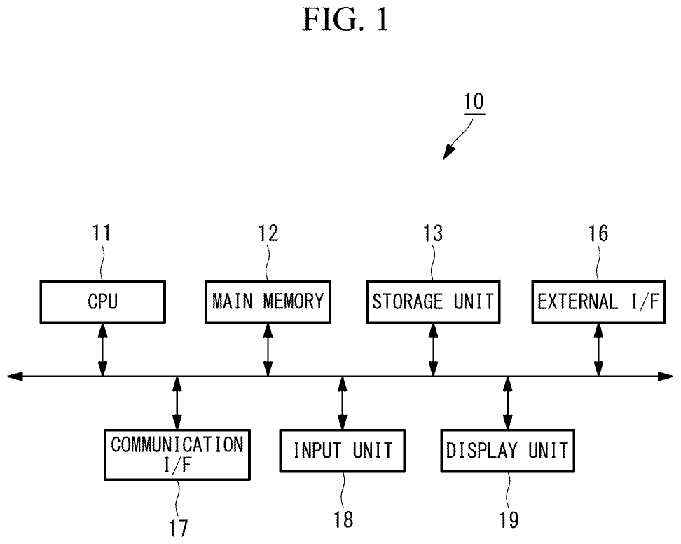

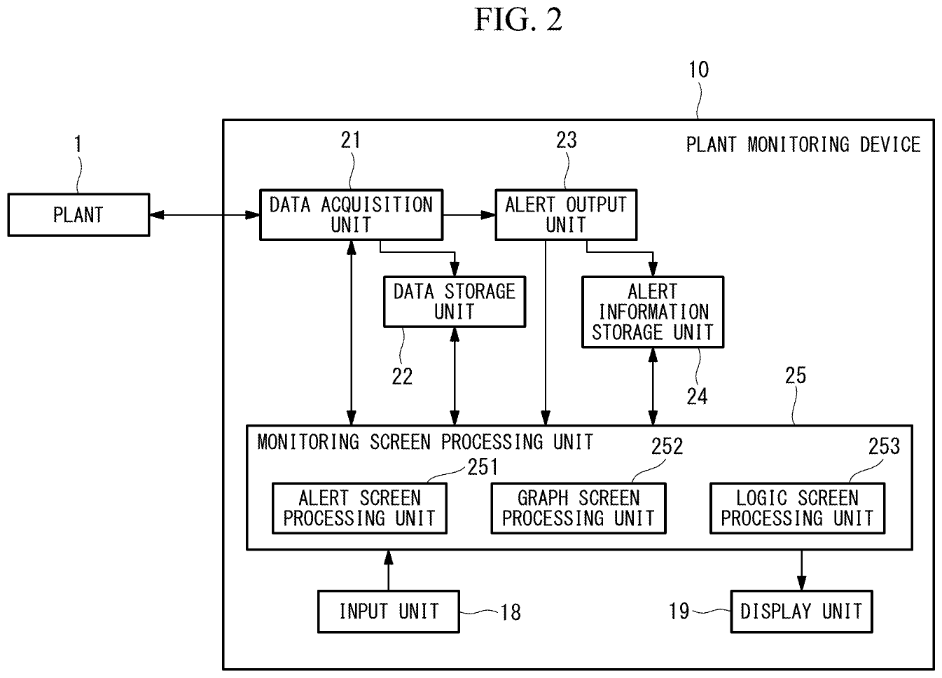

FIG. 1 is a diagram illustrating an example of a hardware configuration of a plant monitoring device 10 according to one embodiment of the present disclosure. As illustrated in FIG. 1, the plant monitoring device 10 has, for example, a central processing unit (CPU) 11, a main memory 12, a storage unit 13, an external interface 16, a communication interface 17, an input unit 18, a display unit 19, and the like. These units are connected to each other directly or indirectly via a bus and perform various processes in cooperation with each other.

The CPU 11 performs overall control of the plant monitoring device 10 by using operating system (OS) stored in the storage unit 13 connected via a bus and performs various processes by executing various programs stored in the storage unit 13, for example.

The main memory 12 is formed of a writable memory such as a cache memory, a random access memory (RAM) and is used for a work area where an execution program of the CPU 11 is loaded and writing of processing data and the like by the execution program are performed.

The storage unit 13 is, for example, a read only memory (ROM), a hard disk drive (HDD), a solid state drive (SSD), or the like, and, for example, OS used for performing overall control of the plant monitoring device 10, such as Windows (registered trademark), various device driver used for performing hardware operation on peripheral equipment, various programs used for implementing various processes (including various application software), various data required for implementing various processes, or the like are stored therein.

The external interface 16 is an interface used for connecting to an external device. An example of the external device may be an external monitor, a USB memory, an external HDD, or the like. Note that, although only one external interface is depicted in the example illustrated in FIG. 1, a plurality of external interfaces may be provided.

The communication interface 17 functions as an interface used for connecting to a network to communicate with another device and transmitting and receiving information.

The input unit 18 is a user interface by which a user provides an instruction to the plant monitoring device 10, such as a keyboard, a mouse, a touch panel, or the like, for example.

The display unit 19 has a display screen formed of a liquid crystal display (LCD), organic electro luminescence (EL), or the like and displays a result or the like of an application or the like executed by the plant monitoring device 10, for example,

FIG. 2 is a function block diagram illustrating an example of functions of the plant monitoring device 10 according to the present embodiment.

A series of processes for implementing various functions described later are stored in the storage unit 13 in a form of a program (for example, a plant monitoring program) as an example, and the CPU 11 loads this program into the main memory 12 to perform modification or calculation processing on information, and thereby respective functions are implemented. Note that, for a program, a form in which the program is installed in advance in the storage unit 13, a form in which the program is provided in a state of being stored in another computer readable storage medium, a form in which the program is delivered via a wired or wireless communication connection, or the like may be applied. The computer readable storage medium may be a magnetic disk, an optical magnetic disk, a CD-ROM, a DVD-ROM, a semiconductor memory, or the like.

As illustrated in FIG. 2, the plant monitoring device 10 has a data acquisition unit 21, a data storage unit 22, an alert output unit 23, an alert information storage unit 24, a monitoring screen processing unit 25, and the like.

The data acquisition unit 21 acquires input data that is data used for monitoring the plant 1. The “input data” includes measured data, such as a temperature, a pressure, a flow rate, or the like, measured by various sensors provided to the plant 1, various control amounts output from various control devices of the plant 1, and various data or the like required for monitoring the plant 1 other than the above.

The data acquisition unit 21 stores the acquired input data in the data storage unit 22 in association with information for identifying the input data (hereafter, referred to as “monitoring item”) and time information on the time of acquisition of the input data.

Various input data acquired by the data acquisition unit 21 is stored in the data storage unit 22 in association with a monitoring item and time information. In the present embodiment, a “monitoring item” includes ID information (tag) that is identification information on the monitoring item and the name of the monitoring item.

The alert output unit 23 has a normal range of input data for all or some monitoring items, for example. The alert output unit 23 detects an anomaly when the input data of the monitoring item is out of the normal range. In response to detecting the anomaly, the alert output unit 23 creates alert information about the detected anomaly. The alert output unit 23 stores the created alert information in the alert information storage unit 24 and outputs the created alert information to the monitoring screen processing unit 25. The alert output unit 23 detects a recovery from an anomaly when the input data on the monitoring item that has been out of the normal range transitions into the normal range. In response to detecting the recovery from the anomaly, the alert output unit 23 creates alert information about the recovery, stores the created alert information in the alert information storage unit 24, and outputs the created alert information to the monitoring screen processing unit 25.

The scheme to detect an anomaly and a recovery by the alert output unit 23 is not limited to the example described above, and a known scheme can be employed as appropriate.

The alert information includes an alert ID, information about a monitoring item, the plant state, and time information. The information about the monitoring item may be, for example, the ID of the monitoring item, the name of the monitoring item, or the like. The plant state may be, for example, an abnormal state or a recovered state. The time information may be a date and time of occurrence of an anomaly or a date and time of a recovery.

The monitoring screen processing unit 25 includes an alert screen processing unit 251, a graph screen processing unit 252, and a logic screen processing unit 253.

The alert screen processing unit 251 displays an alert screen, which includes an alert element based on alert information, on the display unit 19 when accepting the alert information from the alert output unit 23. For example, the alert screen processing unit 251 extracts the whole or a part of information of the alert information to create an alert element and displays this alert element in the alert screen. The alert screen is, for example, an alarm summary and a screen in which alert elements are listed and displayed. In the alert screen, the alert element may be displayed in time-series based on the date and time of an anomaly or a recovery.

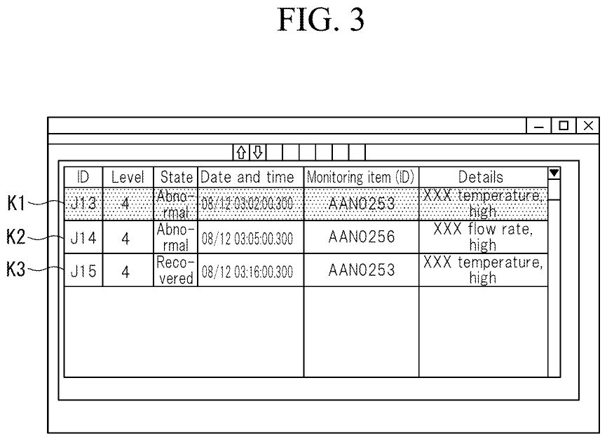

FIG. 3 illustrates an example of the alert screen. As illustrated in FIG. 3, alert elements K1 to K3 based on currently occurring alert information are displayed in the alert screen (alert window). In the alert screen illustrated as an example in FIG. 3, each of the alert elements K1 to K3 includes, for example, an alert ID, an alert level, a plant state, a date and time (a date and time of occurrence of an anomaly or a date and time of a recovery), a monitoring item, and detailed information.

When accepting a display instruction of an alert screen from the input unit 18, the alert screen processing unit 251 creates an alert screen based on the display instruction and displays the alert screen on the display unit 19. For example, when a display instruction and period information about an alert screen are input from the input unit 18, the alert screen processing unit 251 reads the alert information occurring in the period information input from the alert information storage unit 24, creates an alert screen based on the read alert information, and displays the alert screen on the display unit 19.

The graph screen processing unit 252 displays, on the display unit 19, a trend graph screen in which a temporal change of input data related to a monitoring item of the plant 1 is rendered as a graph. For example, the graph screen processing unit 252 acquires input data corresponding to a monitoring item set in advance from the data acquisition unit 21 or the data storage unit 22, creates a graph based on the acquired input data, and displays the graph in the trend graph screen.

Graphs for a plurality of monitoring items may be displayed in the trend graph screen. The monitoring item graphically displayed in the trend graph screen can be set, added, or changed as appropriate by the user.

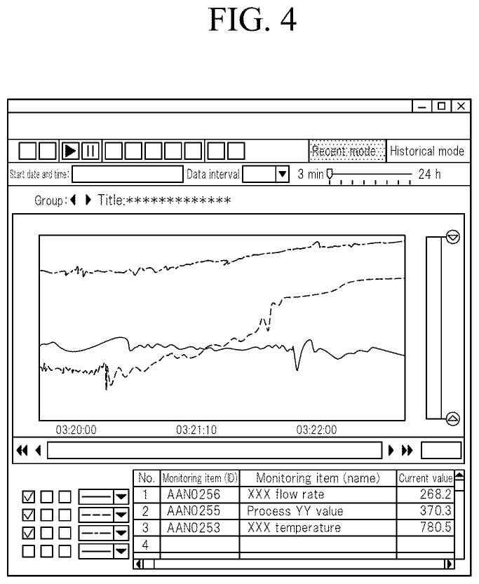

FIG. 4 is a diagram illustrating an example of the trend graph screen (trend graph window). As illustrated in FIG. 4, in the trend graph screen, graphs based on input data on monitoring items set by the user are displayed. In the trend graph screen, a recent mode and a historical mode are provided. When the recent mode is selected, the graph screen processing unit 252 acquires input values of the monitoring item to be displayed at any time from the data acquisition unit 21 and displays a graph based on the acquired input value in the trend graph screen. Accordingly, the latest input data for each monitoring item is updated at any time and displayed in the trend graph screen. When the historical mode is selected, the graph screen processing unit 252 acquires, from the data storage unit 22, the input data in the past predetermined period designated by the user and displays a graph based on the acquired input data in the trend graph screen. At this time, the time axis range may be adjusted in accordance with the length of the designated period.

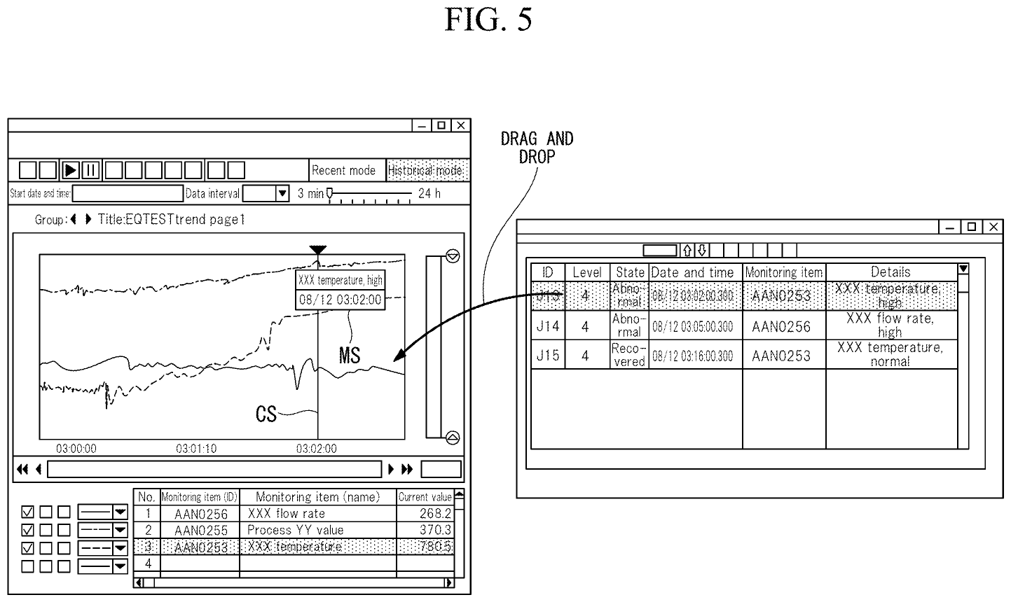

When the user operates the input unit 18 (for example, a mouse or the like) and drags and drops an alert element displayed in the alert screen to the trend graph screen in a state where the alert screen and the trend graph screen are displayed on the display unit 19 as illustrated in FIG. 5, the graph screen processing unit 252 determines the dragged and dropped alert element and updates the trend graph screen based on the determined alert element.

For example, the graph screen processing unit 252 acquires, from the data storage unit 22, input data on a predetermined period (for example, a predetermined period before and after the acquired date and time including the same) including a date and time determined from the dragged and dropped alert element. At this time, the monitoring item for which input data is acquired may be a monitoring item that is being currently set to be displayed in the trend graph screen or may be limited to the monitoring item about the alert element.

Further, the graph screen processing unit 252 displays a highlighting element that highlights a date and time of occurrence of an anomaly or a date and time of a recovery in the trend graph screen. The highlighting element will be described later.

For example, as illustrated in FIG. 5, when an alert element whose ID is “J13” is dragged and dropped from the alert screen to the trend graph screen, a date and time of occurrence of an anomaly of “August 12, 3:02” included in this alert element is acquired, and input data for a predetermined period including the acquired “August 12, 3:02” is acquired from the data storage unit 22. At this time, the input data to be acquired may be limited to the monitoring item “AAN0253” of “J13” or may be the monitoring items “AAN0256”, “AAN0255”, and “AAN0253” set in advance. These may also be settable by the user.

Accordingly, for example, as illustrated in FIG. 5, the graph related to input data before, at, and after the date and time of occurrence of the anomaly is displayed in the trend graph screen.

The graph screen processing unit 252 displays a highlighting element for highlighting a date and time of occurrence of an anomaly in the trend graph screen. An example of the highlighting elements may be, for example, a form such as displaying a cursor CS at the time, displaying a message MS indicating the time, or the like, as illustrated in FIG. 5. Accordingly, it is possible to easily notify the user of a time of occurrence of an anomaly or a temporal change of input data on a monitoring item for occurrence of an anomaly.

Further, when a plurality of alert elements are collectively dragged and dropped, the graph screen processing unit 252 adjusts the time axis range so that dates and times of occurrence of anomalies included in the plurality of designated alert elements are displayed in the trend graph screen.

Specifically, the graph screen processing unit 252 acquires dates and times from the plurality of dragged and dropped alert elements and acquires the input data for a predetermined period including all the acquired dates and times from the data storage unit 22. At this time, the input data to be acquired is input data on a monitoring item about the dragged and dropped alert element. The graph screen processing unit 252 adjusts the time axis range so that the dates and times determined by all the dragged and dropped alert elements are displayed in the trend graph screen. Accordingly, respective alert elements and temporal changes of input data related to respective monitoring items can be presented to the user.

The graph screen processing unit 252 preferably displays the trend for each monitoring item in the trend graph screen and a plurality of alert elements in the alert screen in association with each other. For example, when any one of a plurality of dragged and dropped alert elements is selected (for example, clicked) in the alert screen, the graph of a trend graph screen corresponding to the selected alert element may be displayed in a different form from other graphs (for example, turning on and off, changing color or thickness, or the like). Accordingly, a temporal change of input data on a selected alert element can be presented to the user in an easy-to-understand manner.

Further, instead of the display example described above, each alert element in the alert screen and each graph in the trend graph screen corresponding thereto may be displayed in the same color. For example, in FIG. 5, when three alert elements related to the alert element IDs “J13”, “J14”, and “J15” are dragged and dropped from the alert screen to the trend graph screen, first, the “J13” and “J15” are alert elements about occurrence of an anomaly and a recovery for a common monitoring item “AAN0253”. In such a case, the alert screen processing unit 251 and the graph screen processing unit 252 cause the graph of the monitoring item “AAN0253” in the trend graph screen and the alert elements “J13” and “J15” in the alert screen to be displayed in the same color. Further, for the alert element ID “J14”, a graph of the monitoring item “AAN0256” in the trend graph screen and the alert element “J14” in the alert screen are displayed in the same color. This enables the user to easily understand the relationship between each alert element in the alert screen and each graph in the trend graph screen.

The logic screen processing unit 253 extracts a control logic from a control logic storage unit (not illustrated) that stores control logic information on the plant 1. The logic screen processing unit 253 creates a logic screen based on the extracted control logic and displays the logic screen on the display unit 19.

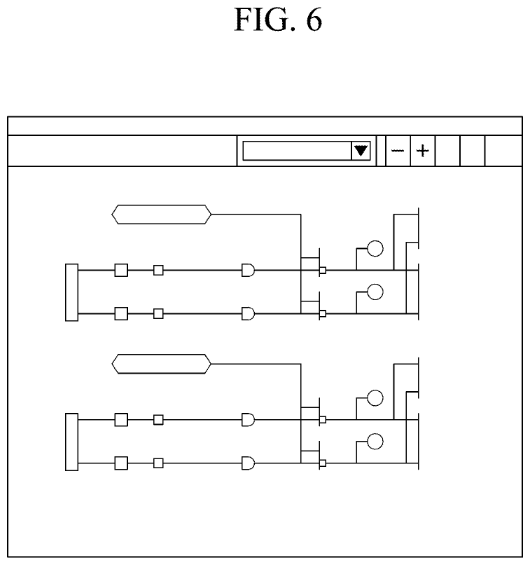

FIG. 6 is a diagram illustrating an example of the logic screen. As illustrated in FIG. 6, in the logic screen, for example, a control logic of a plant is displayed, and the current control status is also displayed in a visible manner.

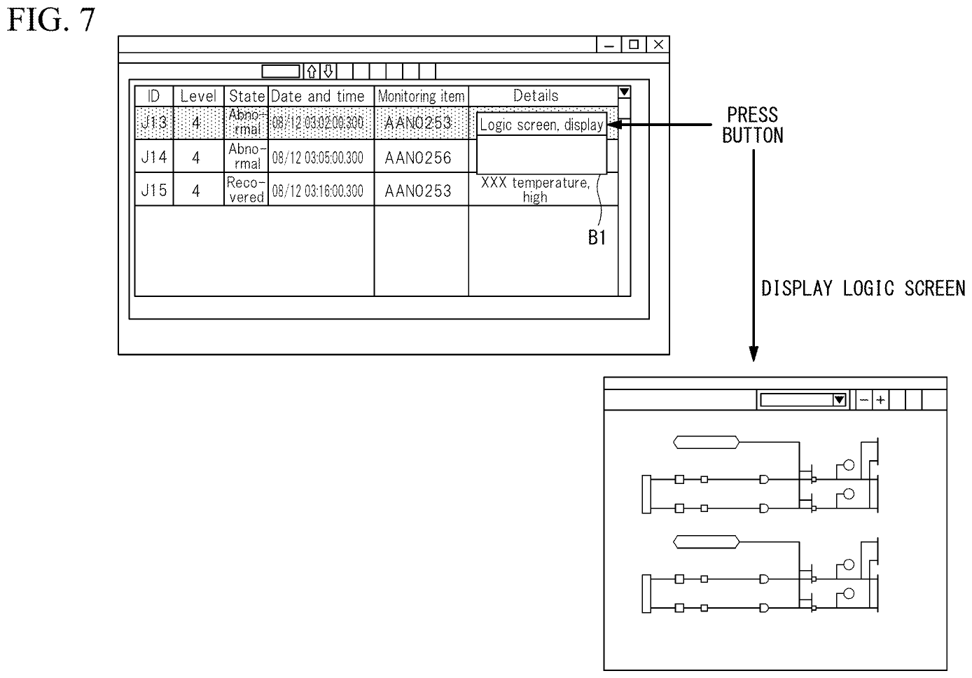

For example, when any of the alert elements is selected in the alert screen and a predetermined input operation is further performed, as illustrated in FIG. 7, the logic screen processing unit 253 acquires a control logic about the designated alert element from the control logic storage unit (not illustrated). The logic screen processing unit 253 creates a logic screen based on the acquired control logic and displays the logic screen on the display unit 19. An example of the predetermined input operation may be, for example, an operation to press a menu button B1 provided in the alert screen and for displaying the logic screen. This menu button B1 may be always displayed at a predetermined position in the alert screen or may be configured to be temporarily displayed when the alert element is designated and right-clicked. The input means for displaying the logic screen can be any operation interface on which an input operation such as clicking can be made without being limited to the menu button B1 described above.

When any graph is selected and a predetermined input operation is performed in the trend graph screen, the logic screen processing unit 253 may display a logic screen about a monitoring item corresponding to the selected graph on the display unit 19. Accordingly, various graphs displayed in the trend graph screen and the logic screen can be cooperated with each other.

Next, a plant monitoring method according to the present embodiment will be described.

The data acquisition unit 21 acquires input data from the plant 1. The input data on the plant 1 may be input via a control device (not illustrated) that controls the plant 1 or may be input directly from various sensors provided to the plant 1. That is, the scheme to acquire input data in the plant 1 is not particularly limited. The data acquisition unit 21 associates and stores the acquired input data with the monitoring item and time information thereon in the data storage unit 22 and outputs them to the alert output unit 23.

The alert output unit 23 compares the input data with a normal range, detects an anomaly when the input data is out of the normal range, and creates alert information about the detected anomaly. The alert output unit 23 detects a recovery from the anomaly when the input data that has been out of the normal range transitions into the normal range and creates alert information about the detected recovery from the anomaly. The created alert information is stored in the alert information storage unit 24 and output to the monitoring screen processing unit 25.

The alert screen processing unit 251 creates an alert screen based on the alert information and displays the alert screen on the display unit 19.

When an instruction to display a trend graph screen is input from the input unit 18, the graph screen processing unit 252 creates a trend graph screen based on the input information and displays the trend graph screen on the display unit 19. When the alert information is output, the graph screen processing unit 252 may automatically display the trend graph screen on the display unit 19.

When the input unit 18 is operated by the user and one or a plurality of alert elements that have been displayed in the alert screen are dragged and dropped to the trend graph screen in a state where the alert screen and the trend graph screen are displayed on the display unit 19 (for example, see FIG. 5), one or more graphs based on input data for the date and time determined by the dragged and dropped alert elements are displayed in the trend graph screen. Accordingly, the graph at the date and time of occurrence of an anomaly or/and the date and time of a recovery from an anomaly about the alert element selected by the user is displayed in the trend graph screen, and highlighting display is made on the date and time of the occurrence of the anomaly or/and the date and time of the recovery from the anomaly.

Further, when any of the alert elements is selected and a predetermined input operation is performed in the alert screen or when any of the graphs is selected and a predetermined input operation is performed in the trend graph screen, the logic screen processing unit 253 creates a logic screen based on a control logic about the selected monitoring item and displays the logic screen on the display unit 19.

As described above, according to the plant monitoring device, the plant monitoring method, and the program of the present embodiment, in a screen in which an alert screen and a trend graph screen are displayed, when one or a plurality of alert elements displayed in the alert screen are dragged and dropped to the trend graph screen, one or more graphs including the date and time determined by the one or a plurality of dragged and dropped alert elements are displayed in the trend graph screen. This enables the user to cause a graph about a desired alert element to be displayed in the trend graph screen by a single operation of a drag-and-drop operation, which can enhance convenience. As a result, the user is able to quickly take an action or decision for plant recovery, and this can shorten the time from stop to recovery of the plant and reduce a lost profit.

Since a date and time of occurrence of an anomaly or a recovery is highlighted and displayed in the trend graph screen, the user is able to easily see how the input data has changed before and after the date and time.

When a plurality of alert elements are dragged and dropped to the trend graph screen from the alert screen, the time axis range is adjusted so that the dates and times of occurrence of an anomaly determined by the plurality of designated alert elements are displayed in the trend graph screen. This enables the user to compare and see the changes of input data on respective monitoring items for the plurality of alert elements and comprehensively judge the factor or the like of occurrence of an anomaly.

When a plurality of alert elements are dragged and dropped to the trend graph screen from the alert screen, since trends related to a plurality of monitoring items displayed in the trend graph screen and the plurality of alert elements in the alert screen are associated with each other and displayed, it is possible to easily understand which alert element each graph in the trend graph screen corresponds to.

Although one embodiment of the present disclosure has been described above, the technical scope of the present disclosure is not limited to the scope described in the above embodiment. Various modification or improvement can be added to the above embodiment within the scope not departing from the spirit of the invention, and a form to which such modification or improvement is added is also included in the technical scope of the present disclosure.

For example, although the plant monitoring device 10 includes the data storage unit 22 and the alert information storage unit 24 in the embodiment described above, these storage units may be configured to be stored on a server (for example, a cloud server or the like) connected over a network, for example, without being limited to the above example.

The plant monitoring device, the plant monitoring method, and the program according to one embodiment described above are understood as follows, for example.

The plant monitoring device (10) according to the present disclosure includes: an alert output unit (23) configured to, when an anomaly of a plant (1) is detected, create alert information including a date and time of occurrence of the anomaly; an alert screen processing unit (251) configured to display, on a display unit (19), an alert screen including an alert element based on the alert information; and a graph screen processing unit (252) configured to display, on the display unit, a trend graph screen in which a temporal change of input data related to a monitoring item of the plant is rendered as a graph. When the alert element displayed in the alert screen is dragged and dropped to the trend graph screen in a state where the alert screen and the trend graph screen are displayed on the display unit, the graph screen processing unit displays, in the trend graph screen, a graph of input data for a predetermined period including the date and time determined from the dragged and dropped alert element and displays a highlighting element for highlighting the date and time in the trend graph screen.

According to the plant monitoring device of the present disclosure, it is possible to cause a graph about a desired alert element to be displayed in the trend graph screen by a single operation of a drag-and-drop operation, which can enhance convenience of plant monitoring. Since the date and time of occurrence of an anomaly is highlighted and displayed in the trend graph screen, the user is able to easily see how the input data has changed before and after the date and time of the occurrence of the anomaly.

In the plant monitoring device according to the present disclosure, when a recovery from an anomaly of the plant is detected, the alert output unit may create alert information including a date and time of the recovery.

According to the plant monitoring device of the present disclosure, the alert information not only at occurrence of an anomaly but also at a recovery from the anomaly is created. This enables the user to easily see how the input data has changed before and after the date and time of the recovery from the anomaly.

In the plant monitoring device according to the present disclosure, when a plurality of alert elements are dragged and dropped to the trend graph screen from the alert screen, the graph screen processing unit may adjust a time axis range so that each date and time determined from each of the plurality of alert elements is displayed in the trend graph screen.

According to the plant monitoring device of the present disclosure, this enables the user to compare and see the changes of input data on respective monitoring items for the plurality of alert elements and comprehensively judge the factor or the like of occurrence of an anomaly.

In the plant monitoring device according to the present disclosure, when the plurality of alert elements are dragged and dropped to the trend graph screen from the alert screen, the graph screen processing unit may display each of the alert elements in the alert screen and each graph displayed in the trend graph screen in association with each other.

According to the plant monitoring device of the present disclosure, the user is able to easily understand which alert element each graph in the trend graph screen corresponds to.

The plant monitoring method according to the present disclosure is performed by a computer, and the plant monitoring method includes steps of: when an anomaly of a plant is detected, creating alert information including a date and time of occurrence of the anomaly; displaying, on a display unit, an alert screen including an alert element based on the alert information; displaying, on the display unit, a trend graph screen in which a temporal change of input data related to a monitoring item of the plant is rendered as a graph; and when the alert element displayed in the alert screen is dragged and dropped to the trend graph screen in a state where the alert screen and the trend graph screen are displayed on the display unit, displaying, in the trend graph screen, a graph of input data for a predetermined period including the date and time determined from the dragged and dropped alert element and displaying a highlighting element for highlighting the date and time in the trend graph screen.

The program according to the present disclosure causes a computer to function as the plant monitoring device described above.

### REFERENCE SIGNS LIST

1 plant
10 plant monitoring device
13 storage unit
18 input unit
19 display unit
21 data acquisition unit
22 data storage unit
23 alert output unit
24 alert information storage unit
25 monitoring screen processing unit
251 alert screen processing unit
252 graph screen processing unit
253 logic screen processing unit

1. A plant monitoring device comprising:
an alert output unit configured to, when an anomaly of a plant is detected, create alert information including a date and time of occurrence of the anomaly;
an alert screen processing unit configured to display, on a display unit, an alert screen including an alert element based on the alert information; and
a graph screen processing unit configured to display, on the display unit, a trend graph screen in which a temporal change of input data related to a monitoring item of the plant is rendered as a graph,
wherein when the alert element displayed in the alert screen is dragged and dropped to the trend graph screen in a state where the alert screen and the trend graph screen are displayed on the display unit, the graph screen processing unit displays, in the trend graph screen, a graph of input data for a predetermined period including the date and time determined from the dragged and dropped alert element and displays a highlighting element for highlighting the date and time in the trend graph screen.

2. The plant monitoring device according to claim 1, wherein when a recovery from an anomaly of the plant is detected, the alert output unit creates alert information including a date and time of the recovery.

3. The plant monitoring device according to claim 1, wherein when a plurality of alert elements are dragged and dropped to the trend graph screen from the alert screen, the graph screen processing unit adjusts a time axis range so that each date and time determined from each of the plurality of alert elements is displayed in the trend graph screen.

4. The plant monitoring device according to claim 3, wherein when the plurality of alert elements are dragged and dropped to the trend graph screen from the alert screen, the graph screen processing unit displays each of the alert elements in the alert screen and each graph displayed in the trend graph screen in association with each other.

5. A plant monitoring method performed by a computer, the plant monitoring method comprising:
when an anomaly of a plant is detected, creating alert information including a date and time of occurrence of the anomaly;
displaying, on a display unit, an alert screen including an alert element based on the alert information;
displaying, on the display unit, a trend graph screen in which a temporal change of input data related to a monitoring item of the plant is rendered as a graph; and
when the alert element displayed in the alert screen is dragged and dropped to the trend graph screen in a state where the alert screen and the trend graph screen are displayed on the display unit, displaying, in the trend graph screen, a graph of input data for a predetermined period including the date and time determined from the dragged and dropped alert element and displaying a highlighting element for highlighting the date and time in the trend graph screen.

6. A non-transitory computer-readable storage medium storing a program that causes a computer to function as the plant monitoring device according to claim 1.

7. The plant monitoring device according to claim 2, wherein when a plurality of alert elements are dragged and dropped to the trend graph screen from the alert screen, the graph screen processing unit adjusts a time axis range so that each date and time determined from each of the plurality of alert elements is displayed in the trend graph screen.

8. A non-transitory computer-readable storage medium storing a program that causes a computer to function as the plant monitoring device according to claim 2.

9. A non-transitory computer-readable storage medium storing a program that causes a computer to function as the plant monitoring device according to claim 3.

10. A non-transitory computer-readable storage medium storing a program that causes a computer to function as the plant monitoring device according to claim 4.
